(19) United States
(12) Patent Application Publication
(10) Pub. No.: US 2025/0095020 A1
(43) Pub. Date: Mar. 20, 2025

(54) METHOD AND SYSTEM FOR INQUIRING PERSONAL DATA NECESSARY FOR TARGET MARKETING AND REWARDING FOR THE INQUIRING

(71) Applicant: SALTMINE, INC., Cheonan-si, Chungcheongnam-do (KR)

(72) Inventor: Chang Hyun YOO, Hanam-si, Gyeonggi-do (KR)

(73) Assignee: SALTMINE, INC., Cheonan-si, Chungcheongnam-do (KR)

(21) Appl. No.: 18/725,813

(22) PCT Filed: May 26, 2022
(86) PCT No.: PCT/KR2022/007510

§ 371 Date: Jul. 1, 2024

(30) Foreign Application Priority Data
Mar. 28, 2022 (KR) 10-2022-0038041

(51) Int. Cl. G06Q 30/0207; H04L 9/14

(52) U.S. Cl. CPC G06Q 30/0236; H04L 9/14; G06Q 2220/10

(57) ABSTRACT

The present invention relates to a system and method for obtaining and safely storing users' personal data, appropriately providing the stored personal data to companies requiring the personal data, and providing rewards to the users for providing the personal data, wherein, by storing personal data on a blockchain and allowing a user whose identity has been authenticated through a DID method to grant a company member access authority to his or her personal data, the company member may obtain personal data and use the personal data for marketing.

### TECHNICAL FIELD

The present invention relates to target marketing, and more specifically, to a system and method for obtaining and safely storing users' personal data, appropriately providing the stored personal data to companies requiring the personal data, and providing rewards to the users for providing the personal data.

### BACKGROUND ART

Target marketing refers to segmenting and setting marketing targets and conducting marketing only to specific targets, rather than indiscriminately conducting promotional marketing targeting all customers. Since the target marketing is conducted on limited customers having a high probability of purchasing or using the product, the marketing is highly effective and has the effect of reducing marketing costs compared to indiscriminate marketing.

To conduct target marketing, customers' personal data is essentially required. This is because the personal data has to be looked up and an analysis has to be performed based on the lookup to determine whether a specific customer is interested in or is in a demand class that may be interested in a company's services or products. Personal data may include sensitive personal information such as gender, age, an address, an education level, an income level, marital status, a purchase history, a residence type, and the like.

In Korea, the Information and Communications Network Act stipulates that when a business collects customer personal data to provide a service, the business has to collect only personal data necessary to perform essential functions of the service, and the use and collection of personal data for marketing purposes or service improvement is “optional.” Users may provide personal data to specific organizations for marketing purposes by consenting to the terms and conditions or consenting to the use and collection of personal data (that is, 1:1 provision). However, after users give consent, the users are ignorant of where their personal data are provided or for what purpose.

In addition, currently, personal data may be built into big data and used for marketing, but such personal data is de-identified so that private details are not allowed to be known, and thus has limitations, and in addition, individuals do not have control over the distribution and use of their personal data, and thus are not aware that their personal data are being used.

Prior literature (Korean registered patent KR 10-1729646) discloses a configuration in which control of personal data is given to an intermediary based on conditions preset by individuals and companies, but still does not disclose any technology for safely storing personal data without giving individuals control over their personal data.

Prior literature (Korean registered patent KR 10-2257403) discloses a configuration for providing personal data to other entities, but for the configuration, since a determination as to whether or not personal data is to be read is automatically made depending on the scope of use permission in advance by a user, or a level of risk at which a user may be identified or inferred is measured and a determination as to whether or not personal data is to be read is made based on the level of risk, there is difference from giving an individual control over his or her own personal data, and since reading of personal data is not permitted when there is high possibility of the individual being identified, there is a difficulty in being used for target marketing using identified personal data.

### DISCLOSURE OF THE INVENTION

### Technical Problem

Currently, personal data may be built into big data and used for marketing, but such personal data is de-identified so that private details are not allowed to be known, and thus has limitations, and in addition, individuals do not have control over the distribution and use of their personal data, and thus are not aware that their personal data are being used.

### Technical Solution

Sensitive personal data (or personal information) may be safely stored and provided to companies that require personal data with the permission of a personal data subject. A system may be provided in which companies conduct marketing using personal data and a personal data subject are informed of the details of personal data use and a reward is provided to the personal data subject at the same time.

The technical problem to be solved by the present embodiment is not limited to the technical problem described above, and other technical problems could be inferred from the following embodiments.

### Advantageous Effects

It is possible to safely store personal data and provide the personal data to companies that require the personal data with the permission of a personal data subject. A system can be provided in which companies conduct marketing using personal data and a personal data subject are informed of the details of personal data use and a reward is provided to the personal data subject at the same time. Therefore, there is an advantage in that personal data can be controlled by a person of the personal data and can be transparently traded.

### BRIEF DESCRIPTION OF THE DRAWINGS

FIG. 1 shows a personal data reading and rewarding system in which a person, who is a subject of personal data, is able to control his or her personal data, according to one embodiment.

FIG. 2 shows a personal data reading and rewarding method, according to one embodiment.

FIG. 3 shows a decentralized identifier (DID) unique number stored in a user terminal and a DID document stored on a blockchain, according to one embodiment.

FIG. 4 shows screens that appear when a request is received and when the request is accepted on a user terminal, according to one embodiment.

FIGS. 5 and 6 show a screen of an application installed on a user's smartphone for services for reading personal data and providing a reward, according to one embodiment.

FIG. 7 shows a graph or a neural network for classifying user types, according to one embodiment.

### BEST MODE FOR CARRYING OUT THE INVENTION

A personal data reading and rewarding method includes providing, by a user, personal data of the user to a server, encrypting, by the server, the personal data and storing the encrypted personal data in at least one node on a blockchain, storing a private key and a decentralized identity (DID)-type unique number issued from the server for DID-type identity authentication in a user's terminal and storing a DID document in which a public key corresponding to the private key, issuing information, and identification information about a node storing the personal data are recorded on the blockchain, delivering, by a company member, a request document containing a request for the personal data to the user, confirming, by the user, the request document, allowing accessing the personal data by the user signing the request document with the private key and transmitting a signed document to the server, obtaining, by the server, the personal data by accessing the node based on the identification information about the node recorded in the DID document when integrity of the signature is verified through the blockchain, and providing, by the server, the personal data to the company member.

The delivering, by a company member, a request document containing a request for the personal data to the user may include encrypting, by the server, the request document with the public key and delivering the encrypted request document to the user, and the confirming, by the user, the request document may include decrypting, by the user, the request document with the private key and confirming contents of the request document.

The personal data reading and rewarding method may further include paying a reward to the user when the company receives the personal data, and the reward may increase as the number of companies allowed to read, a type of personal data, or the number of readings increases, and may be paid to the user in a form of cash or mileage that is convertible to cash.

### MODE FOR CARRYING OUT THE INVENTION

In the following, several embodiments will be described clearly and in detail with reference to the accompanying drawings so that those having ordinary skill in the art (hereinafter referred to as those skilled in the art) to which the present invention belongs may easily practice the present invention.

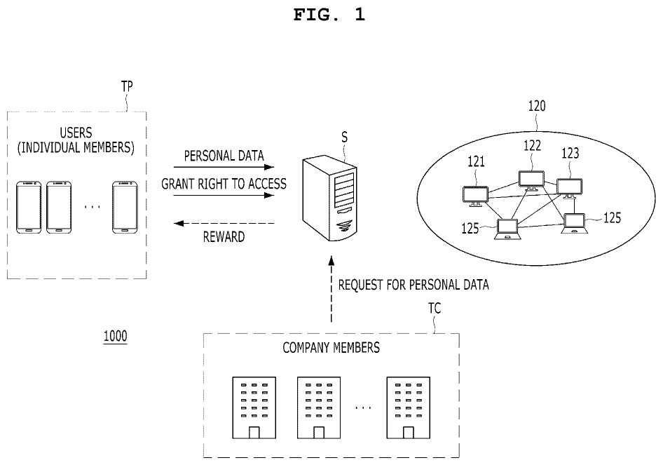

FIG. 1 shows a personal data reading and rewarding system in which a person is able to control his or her personal data, according to one embodiment.

Referring to FIG. 1, a system 1000 may include terminals TP of users (individual members), a server S, and terminals (TC) of company members.

The users' terminals TP may include various electronic devices such as computers, smartphones, tablet PCs, laptops, and wearable devices. For example, on a user's smartphone, a predetermined application for connecting to the server S to provide personal data, confirm to whom the user's personal data is provided, allow reading, and receive a reward for providing the personal data may be installed. Each of the users' terminals TP may store a decentralized identity (DID) unique number for identity authentication using a DID method and a private key.

The system 1000 may include the server S consisting of various types of centralized computing devices or distributed computing devices. For example, the server S may be a central server, a multimedia computer, a laptop computer, a desktop computer, a grid computing resource, a virtualized computer resource, a cloud computing resource, a peer-to-peer distributed computing device, or a combination thereof. The server S may be operated by an entity that develops and provides the above-mentioned application.

The server S may connect to each of the users' terminals TP based on wired and wireless communication interfaces. The server S is an intermediary that safely stores personal data provided by users and delivers the personal data to users when a request to read personal data comes from company members.

According to one embodiment, the server S may store personal data provided by users on a blockchain 120. The blockchain is a data distribution processing technology and refers to a technology that allows all users participating in a network to distribute and store data such as all transaction details. The blockchain may refer to a distributed P2P (peer to peer) system of a ledger that utilizes software elements composed of an algorithm in which blocks connected in order negotiate service usage history information using encryption methods and security technologies to secure and maintain integrity. Here, the distributed P2P system may be a special form of distributed system. In addition, the P2P system allows all nodes in the network to provide resources (processing power, storage space, data, network bandwidth, or the like) to each other without coordination by a central node. In addition, the blockchain may refer to a distributed ledger technology in which a ledger recording usage history information is distributed to a P2P network rather than a central server of a specific organization, and nodes within the network jointly record and manage the usage history information. The server S may encrypt personal data and store it on the blockchain 120. The server S may hash personal data and store the hashed personal data in at least one node on the blockchain 120 in a distributed manner.

The blockchain 120 or the blockchain network 120 may include nodes 121, 122, 123, 124, and 125. A node may refer to a component within the blockchain network. Each of the nodes 121, 122, 123, 124, and 125 may be a server device of individuals who join and participate in the system 1000. For example, each of the nodes 121, 122, 123, 124, and 125 may be special-purpose computer or general-purpose computer of individual members or company members participating in the system 1000, a supercomputer, a mainframe computer, a personal computer, a smartphone, a tablet PC, or the like, but is not limited thereto.

According to one embodiment, the blockchain 120 may be implemented as a private blockchain. While a public blockchain allows anyone to participate and read transaction records without any restrictions, a private blockchain has strong advantages in security and reliability by allowing only verified participants who have undergone separate authentication to participate and restricting reading r of transaction records. In addition, the private blockchain allows personal information to be recorded and modified or destroyed after a certain period of time or when a request occurs. The private blockchain may include, for example, inter-planetary file system (IPFS), hyperledger fabric blockchain, or the like. The public blockchain may include, for example, Stellar, Ethereum, or the like.

According to one embodiment, the server S may store personal data using an inter-planetary file system (IPFS). The IPFS may store personal data in a distributed storage network, and as an example, a hash value of personal data may be stored in the blockchain 120. The personal data distributively stored in IPFS may be searched for and obtained based on hash values.

According to one embodiment, the IPFS consists of a plurality of nodes, and personal data in each node may be divided into small chunks or pieces and then the chunks may be stored in the nodes in a distributed manner. Location information about where the chunks are stored in the distributed manner may be stored on the blockchain 120. According to one embodiment, gender information and age information about a first user may be stored in a first node and a second node on the IPFS, respectively. Alternatively, information on the first user's purchase record may be stored in a plurality of nodes on the IPFS in the distributed manner.

Company members may request personal data of users. The company members may request personal data of specific users among the users. The company members may only request specific personal data among various personal data obtained from the users. According to one embodiment, personal data may include gender, age, an address, an education level, an income level, marital status, a purchase history, a residence type, and the like. Companies may be granted access authority to personal data and, may use the personal data obtained based on the authority for marketing.

A user (individual member) may receive an appropriate reward by providing his or her personal data. Therefore, the user may more actively provide his or her personal data to company members, and the volume and transparency of personal data transactions may be improved.

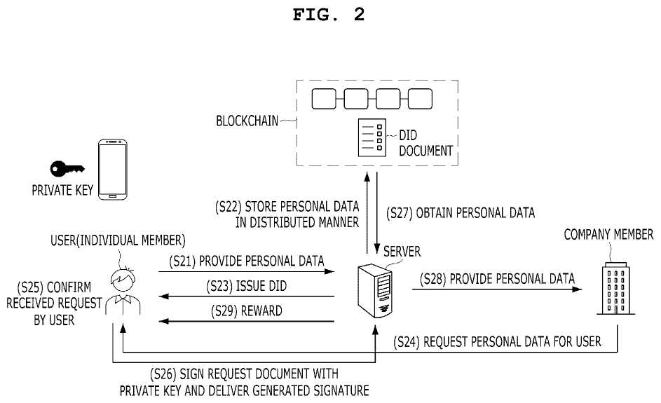

Hereinafter, a personal data reading and rewarding method performed in the system 1000 will be described with reference to FIG. 2. The personal data reading and rewarding method in FIG. 2 may be performed by at least one processor.

FIG. 2 shows a personal data reading and rewarding method, according to one embodiment.

In step S21, a user (individual member) may provide personal data to a server. According to one embodiment, personal data may include gender, age, an address, an education level, an income level, marital status, a purchase history, a residence type, inclination, saved point details, and the like. There are no restrictions on the method by which the server receives personal data from the user. The user may directly enter personal data into the server. Alternatively, personal data may be indirectly provided by the server providing certain survey questions to the user and the user answering the survey questions.

The personal data may include unstructured personal data. The unstructured personal data may include subjective evaluation information that is difficult to express as objective numerical data or items. For example, personal data may include whether the individual member lives with family and acquaintances, whether the individual member is employed, whether the individual member actively searches for, purchases, and uses things he or she need in life, whether the individual member engages in health care and exercise, whether the individual member has hobbies/habits related to interests, whether the individual member is active in seeking out and acquiring new information, whether the individual member is carrying out financial technology and investment-related activities, whether the individual member is carrying out activities related to personal growth and career, whether the individual member is good at controlling his or her emotions, crisis management capabilities to respond when difficult or emergency situations arise, or information about personality or the like, such as Myers-Briggs type indicator (MBTI).

The unstructured personal data may include a user's perception of a specific brand. The user's perception of a specific brand may be determined based on interest, price, purchase frequency, purchase risk, evaluation complexity, decision-making style, or the like. According to one embodiment, the unstructured personal data may be stored as a character string. For example, a user's personality may be stored as a predetermined string expressed as a combination of alphabets and numbers.

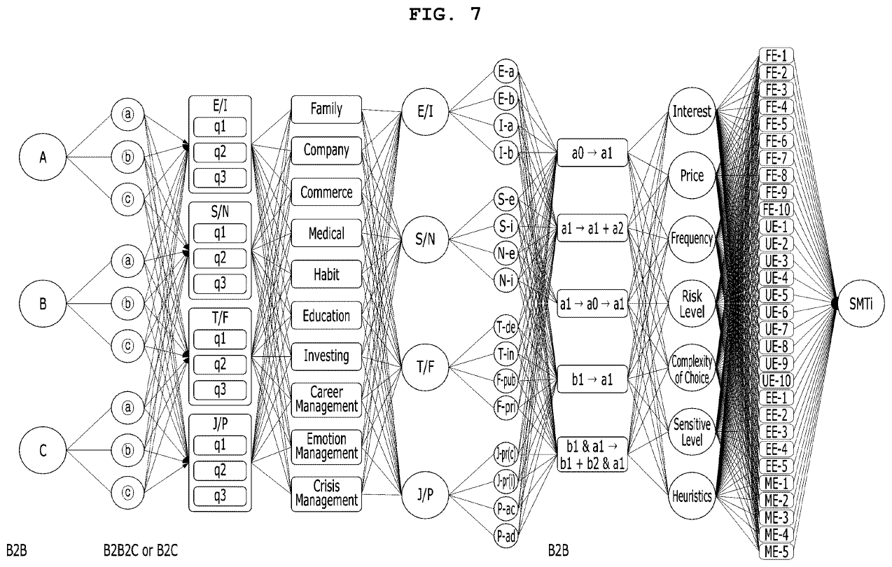

The unstructured personal data may be obtained based on an artificial intelligence model using answers to a questionnaire input by the user as input data. The artificial intelligence model may classify users into a plurality of types based on unsupervised learning of the answers to the input questionnaire. FIG. 7 shows a graph or a neural network used for classifying user types, according to one embodiment.

In step S22, the server may keep or store personal data provided by the user on the blockchain. The server may store personal data provided by the user in at least one node on the blockchain. The personal data stored on the blockchain may be encrypted by an algorithm such as hashing or the like. The server may store a first type of personal data and a second type of personal data in first and second blocks on the blockchain, respectively. As an example, the server may store user A's gender information in a first node on the blockchain and purchase history information in a second node on the blockchain. According to one embodiment, the server may store user A's purchase history information in a plurality of nodes on the blockchain in a distributed manner. According to one embodiment, the server may encrypt personal data and store the encrypted personal data in at least one node on the blockchain. The server may generate a hash value by hashing the personal data and store the hash value in at least one node on the blockchain. Locations of nodes where the information is stored in the distributed manner may be determined based on the hash value of the personal data. According to one embodiment, the blockchain may include an inter-planetary file system (IPFS).

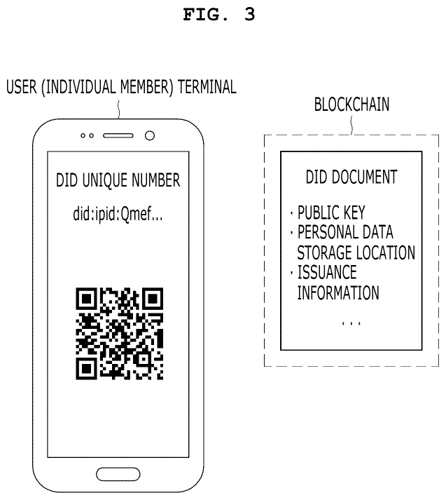

In step S23, the user may receive a private key for identity authentication using the decentralized identifier (DID) method from the server and store a DID unique number and the private key in the terminal. This is for the user who later receives a request to read personal data to allow the request to read by performing identity authentication using the private key. The server may store a DID document on which location information (or identification information) about at least one node in which a public key corresponding to the issued private key, issuance information, or the user's personal data is stored is recorded on the blockchain. FIG. 3 shows a DID unique number stored in a smartphone of the user and a DID document stored on the blockchain, according to one embodiment.

Referring again to FIG. 2, in step S24, a company member may request at least one piece of personal data of the user. According to one embodiment, the server may provide the company member with a list in which at least part of users' personal data has been de-identified, and the company member may request personal data from at least some individual members whose personal data the company member wishes to know from the list. Alternatively, the company member may select the personal data the company member wishes to read. The type of requested personal data may be specified by the company member. For example, the company member may request user A's gender, age, and purchase history information from user A. According to one embodiment, a request document on which a request for personal data is recorded may be encrypted with the user's public key (stored on the blockchain in step S21) and transmitted to the user. For example, when the company member transmits the request document on which the request for personal data is recorded to the server, the server may access the user's DID document on the blockchain, encrypt the request document with the obtained public key, and deliver the encrypted request document to the user.

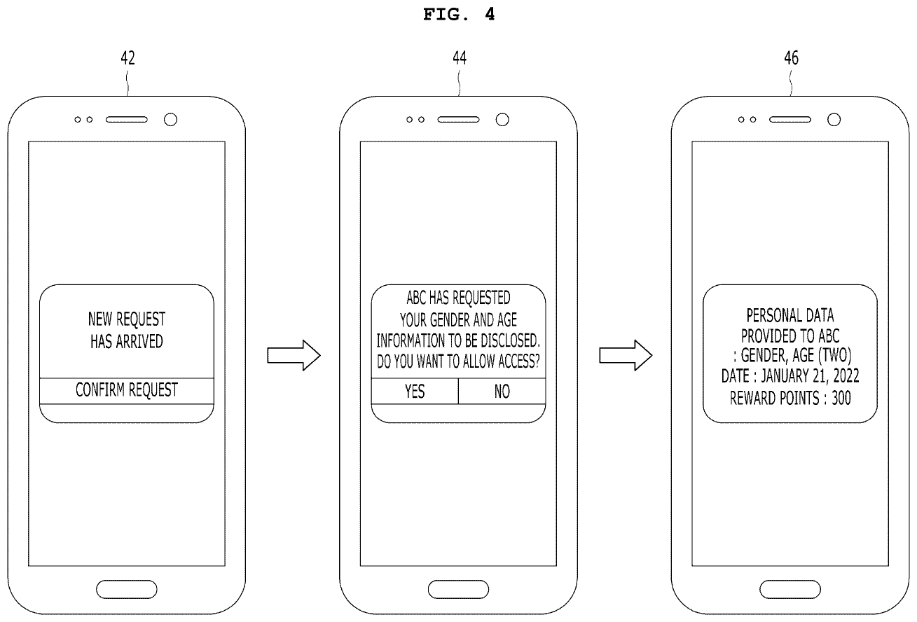

In step S25, the user may confirm and respond to the request document received in step S24. FIG. 4 shows a screen 42 on the user's personal terminal notifying that a new request has arrived. According to one embodiment, the user may confirm the contents of the request by decrypting the received document (encrypted with the public key) using the private key stored on the terminal in step S23. FIG. 4 shows a screen 44 on the user's personal terminal when the user confirms the request.

Referring again to FIG. 2, in step S26, the user may allow reading the personal data. The user may transmit a document obtained by signing the received request document with the private key, that is, a signed document, to the server. When the integrity of the signature is verified through the blockchain, the server may obtain personal data by accessing a specific node on the blockchain through node information (referring to identification information about the node where the personal data is stored) recorded in the DID document (step S27), and deliver the obtained personal data to the company member (step S28). Verification of the integrity of the signature may be performed through decryption using the public key included in the DID document.

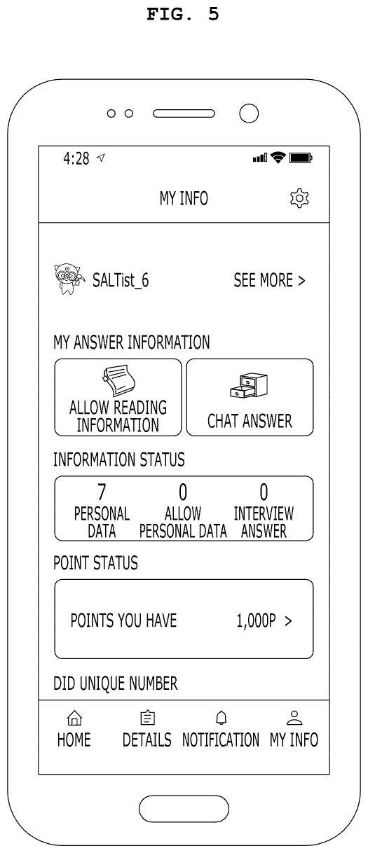

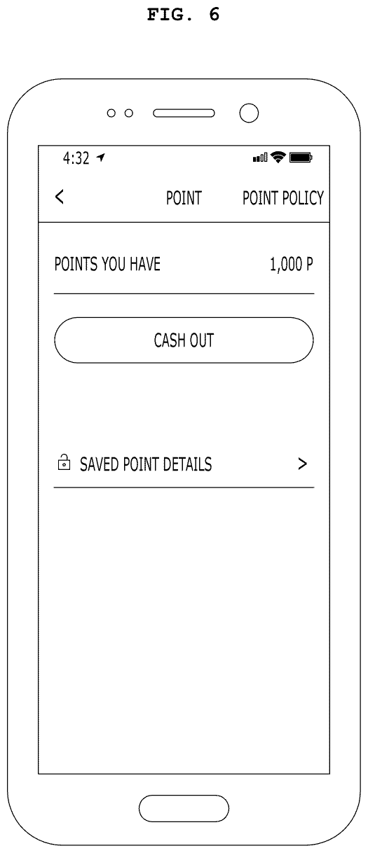

In step S29, the server may pay an appropriate reward to the user for allowing reading the personal data. The reward may increase as the number of companies allowed to read, a type of personal data, or the number of readings increases, and may be paid to a user terminal in a form of cash or mileage that is convertible to cash (refer to 46 in FIG. 4, FIG. 5, and FIG. 6).

The descriptions are intended to provide example configurations and operations for implementing the present invention. The technical spirit of the present invention will include not only the embodiments described above, but also implementations to be obtained by simply changing or modifying the above embodiments. In addition, the technical spirit of the present invention will also include implementations to be easily achieved by changing or modifying the embodiments described above.

1. A personal data reading and rewarding method comprising:
providing, by a user, personal data of the user to a server;
encrypting, by the server, the personal data and storing the encrypted personal data in at least one node on a blockchain;
storing a private key and a decentralized identity (DID)-type unique number issued from the server for DID-type identity authentication in a user's terminal and storing a DID document in which a public key corresponding to the private key, issuing information, and identification information about a node storing the personal data are recorded on the blockchain;
delivering, by a company member, a request document containing a request for the personal data to the user;
confirming, by the user, the request document;
allowing accessing the personal data by the user signing the request document with the private key and transmitting a signed document to the server;
obtaining, by the server, the personal data by accessing the node based on the identification information about the node recorded in the DID document when integrity of the signature is verified through the blockchain; and
providing, by the server, the personal data to the company member.

2. The personal data reading and rewarding method of claim 1, wherein the delivering, by the company, a request document containing a request for the personal data to the user includes encrypting, by the server, the request document with the public key and delivering the encrypted request document to the user, and
the confirming, by the user, the request document includes decrypting, by the user, the request document with the private key and confirming contents of the request document.

3. The personal data reading and rewarding method of claim 1, further comprising paying a reward to the user when the company receives the personal data,
wherein the reward increases as the number of companies allowed to read, a type of personal data, or the number of readings increases, and is paid to the user in a form of cash or mileage that is convertible to cash.
